(19) United States
(12) Patent Application Publication
(10) Pub. No.: US 2007/0089645 A1
(43) Pub. Date: Apr. 26, 2007

(54) Cementitious material reinforced with purified cellulose fiber

(76) Inventors: Gerald Hunt Morton, Germantown, TN (US); Robert Irvin Bell, Collierville, TN (US); Howard Leon Schoggen, Southaven, MS (US); David Jay Smith, Germantown, TN (US)

Correspondence Address: BAKER BOTTS, L.L.P., 30 ROCKEFELLER PLAZA, NEW YORK, NY, 10112-4498, US

(21) Appl. No.: 11/511,809

(22) Filed: Aug. 28, 2006

Related U.S. Application Data
(63) Continuation of application No. PCT/US05/05938, filed on Feb. 23, 2005.
(60) Provisional application No. 60/552,338, filed on Mar. 10, 2004.

(51) Int. Cl. C04B 14/38; C04B 16/00; C04B 16/02; C04B 24/00; C04B 7/00

(52) U.S. Cl. 106/805; 106/804; 106/711

(57) ABSTRACT

The present invention is directed to a cellulose fiber reinforced cementitious material having cement; optionally sand and/or aggregate; and chemically purified cellulose fibers with a Zero-Span Stability Ratio or precent cellulose content of about 90 percent or greater. The invention may also include one or more synthetic or natural fibers, and may also include latex.

### CROSS-REFERENCE TO RELATED APPLICATIONS

This application claims priority under 35 U.S.C. § 119, based on U.S. Provisional Application Ser. No. 60/552,338 filed Mar. 10, 2004, which is hereby incorporated by reference in its entirety.

### FIELD OF THE INVENTION

This invention relates to a cementitious material reinforced with a chemically purified cellulose fiber.

### BACKGROUND OF THE INVENTION

U.S. Pat. Nos. 1,048,913; 1,349,901; 1,571,048; 1,633,219; 1,913,707; 2,377,484; and 2,677,955 relate to the use of various materials including fibers in concrete. Early efforts were aimed at improving crack resistance and improving the energy absorption of concrete masses. U.S. Pat. Nos. 4,188,454; 4,287,365; 4,287,020; 4,310,478; 4,369,201; 4,4,400,217; 4,483,727; 4,524,101; 4,524,101; 4,861,812; 4,985,119; 4,968,561; 5,000,824; 5,196,061; 5,362,562; 5,385,978; 5,399,195; and 5,453,310, 5,643,359, 5,897,701, all of which are hereby incorporated by reference in their entirety, relate to various efforts to provide improved reinforced materials. It was recognized that cellulosic materials were wide spread, abundant and relatively cheap. However, it was also recognized that cellulosic materials were of limited value in many compositions because of the harsh alkaline environment of many cementitious mixtures, which caused physical degradation of the cellulosic fibers in curing of the mixture.

U.S. patent application Ser. No. 10/638,274 filed Aug. 8, 2003 with title “Cementitious Material Reinforced with Chemically Treated Cellulose Fiber”, and hereby incorporated herein by reference in its entirety, discloses chemically treated cellulose fibers with high alkaline stability and their use in cementitious materials.

U.S. Provisional Patent Application Ser. No. 60/498,782 filed Aug. 23, 2003 with title “System for Delivery of Fibers into Concrete”, and hereby incorporated herein by reference in its entirety, discloses forms of sheeted fibrous material which can be easily mixed into construction material compositions with rapid dispersion of individual fibers.

### SUMMARY OF THE INVENTION

It would be advantageous to be able to provide a cellulose fiber for admixture in cementitious materials which is resistant to structural degradation in the harsh alkaline environment of many cementitious mixtures, and, which, therefore, is effective in reinforcement of the microenvironment around individual fibers and in preventing the initiation of microcracks. Further, it would be advantageous to be able to provide such a fiber that does not require a chemical treatment.

This invention discloses cellulose fibers of relatively high purity which provide superior resistance to degradation and loss of strength in the harsh alkaline environment of cementitious materials. It has been found that, while both hemicellulose and lignin contribute to reduced alkaline stability, of the two, the detrimental effect of lignin appears to be greater.

### DESCRIPTION OF THE DRAWINGS

FIG. 1 demonstrates a plot of percent ZSSR versus S10 or percent cellulose for bleached pulps giving the same correlation.

FIG. 2 demonstrates a plot of percent ZSSR versus S10 or percent cellulose for bleached pulps gives the same correlation.

FIG. 3 shows the percent ZSSR values of all samples from Example 6 plotted against the S10 value.

FIG. 4 shows the percent ZSSR values of all samples from Example 6 plotted against purity in which the percent cellulose value is determined by subtracting the S10 value and the percent lignin remaining in the pulp fibers.

### DETAILED DESCRIPTION

All patents, patent applications, and publications cited in this specification are hereby incorporated by reference in their entirety. In case of a conflict in terminology, the present disclosure controls.

Reference is made herein to several standard tests which have been published by the Technical Association for the Pulp and Paper Industry (“TAPPI”), 15 Technology Parkway South, Norcross, Ga. 30092, web site: www.tappi.org. Final test methods are promulgated by TAPPI's Standards Advisory Review Group. Detailed descriptions of these tests are available from TAPPI. A typical designation of a test is, for example, T 233 cm-95 Fiber Length of Pulp by Classification.

Reference is made herein to several ASTM tests. ASTM International is a not-for-profit organization formerly known as the American Society for Testing and Materials, ASTM International, which provides standards that are accepted and used in research and development, product testing, quality systems, and commercial transactions around the globe. ASTM, 100 Bar Harbour Drive, West ConSchohocken Pa, 19428-2959.

A major problem in the state of the art up to now which limits the effectiveness of cellulosic fibers as reinforcement for cementitious materials is the harsh alkaline environment of these materials. When unprotected cellulosic fibers are introduced into this alkaline environment, degradation of the fiber starts immediately in the cementitious mixture before it has a chance to set and cure. It is important that the reinforcing fibers maintain their physical integrity if they are to be effective in reinforcing the cementitious mixture and limiting the formation of microcracks during the curing stages of the cementitious mixture. The chemically purified cellulose fiber of this invention shows stability in a harsh alkaline environment that is superior to a cellulose fiber produced by the same basic method, but which is of lower purity.

Because the chemically purified cellulose fibers of this invention are well bonded into the cementitious matrix, most fibers break rather than pulling free. For this reason, the single fiber strength of cellulose fibers is a very important consideration. To actually break individual fibers is very time consuming and gives highly variable results. A standard method (Tappi T231) was developed to measure the average strength of a large number of fibers by breaking standard paper strips where the gap between the clamping jaws approaches a “zero span” distance, thus ensuring that most of the fibers break rather than pull out of the paper matrix. It is possible to determine the effect of exposure to an alkaline environment on the single fiber strength of cellulose fibers by measuring the zero-span tensile strength of alkali treated and untreated (control) fibers. This effect is expressed as a “Zero-Span Stability Ratio” (ZSSR) as defined below:

$$ZSSR = \frac{Zero \text{-} Span Tensile After Alkaline Treatment}{Zero \text{-} Span Tensile Without Alkaline Treatment} \qquad ( 1 )$$

The ZSSR can be determined for various alkaline treatments and for various time intervals.

A preferred method for the determination of zero-span tensile and ZSSR, which has been designated as ASTM method D 6942-03, follows:

Procedure for Determination of Stability of Cellulose Fibers in Alkaline Environments

This procedure may be used for determining the effect of exposure to alkaline environments on the strength of cellulose fibers. An alkaline environment is defined to be any matrix in which the pH is greater than 8 for a period of 2 or more hours.

The tests and procedures referenced for this procedure are:
ASTM D 1695: Terminology of Cellulose and Cellulose Derivatives, see Annual Book of ASTM Standards, Vol. 6.03.
ASTM D 1348 Standard Test Methods for Moisture in Pulp.
TAPPI T 205: “Forming handsheets for physical tests of pulp”.
TAPPI T 231: “Zero-span breaking strength of pulp (dry zero-span tensile)”.

This procedure can be used to compare different cellulose pulp fiber types based on their response to a standard alkaline solution. The stability factor defined below can be used to measure the effect of exposure to alkaline conditions on fiber strength. Cellulose fibers are treated with a standard alkaline solution for a specified interval, washed free of alkali, and then formed into standard handsheets for strength testing. Zero-span tensile testing is used to determine the effect of the alkaline treatment on fiber strength.

A stability ratio is defined based on the ratio of the zero-span tensile of alkali treated fibers divided by the zero-span tensile of untreated control fibers. A higher number close to 1, or, in terms of percent, closer to 100 percent, indicates relatively greater stability in the alkaline environment while a smaller number indicates a decrease in strength.

This method is intended to provide a generalized procedure for determining the stability of cellulosic pulp fibers exposed to alkaline environments. Specifically, this method allows various pulp types to be compared with respect to the effect of exposure to alkaline conditions on the strength of individual cellulosic fibers based on a zero-span tensile test. The time intervals listed in the procedure are not critical, and more intervals of shorter or longer duration may be added. In addition, the procedure may be simplified by removing some of the intermediate intervals so long as a range of intervals is determined. An example of a simplified procedure would be to determine 4 intervals such as 1 day, 1 week, 2 weeks, 4 weeks; or 1 day, 3 day, 7 day, 14 day.

The specified solution, 1N NaOH, is strongly alkaline. Although this alkali concentration is higher than some environments that would be simulated by this test, the stronger pH provides better differentiation between different cellulose fiber types. Although alkaline stability based on other alkalis, such as KOH, Ca(OH)₂, etc., at a different concentration could be determined by this method, 1N NaOH is to be considered the standard solution. Alkaline stability results from other treatments may be reported in addition to the standard solution if the additional solution(s) provide useful information.

The apparatus required includes Handsheeting apparatus as defined in TAPPI T 205, Zero-span tensile tester as described in TAPPI T 231, Moisture balance and an Analytical balance. 1N sodium hydroxide (NaOH) is a required reagent.

Values stated in SI units are to be regarded as the standard. Values in parentheses are for information only.

Starting cellulose fibers should be in a dry sheet form, such as drylap, or in a dry, low-density bulk form. In tis context, the term dry means at equilibrium moisture content, which is 6-8 percent moisture for most pulps.

Calibration and maintenance of the zero-span tensile tester will be accomplished as prescribed in TAPPI T 231. In addition, a control chart of the instrument will be maintained based on breaking paper strips cut from control sheets of paper. A ream of copy paper can be used for this purpose or any other paper with consistent furnish, uniform basis weight, and uniform density. Control paper produced on a paper machine should be tested in the machine direction.

Handsheets are to be conditioned prior to testing as described in TAPPI T 205.

For drylap, mechanically disintegrate the pulp sheet to get 150 grams of individualized fibers for each sample to be tested. High-density pulp sheets can also be slurried at low consistency, then air-dried to provide a bulk sample of low density. The bulk, air-dry sample can then be disintegrated mechanically or by hand to provide individualized fibers..

To 20 grams, dry basis, of cellulose fibers, add 46.7 grams of 1N NaOH and allow to remain for 24 hours. This corresponds to a 30 percent consistency, corresponding to 20 grams pulp/66.7 grams total. The sample is then placed in an uncovered beaker to simulate an environment that is open to the atmosphere.

Repeat to prepare three more samples that will be left to age for time intervals of, 7, 14, and 28 days, respectively. Once the time interval has been met, work-up of the samples is accomplished by collecting fibers on a 325 mesh wire screen, washing with tap water until washings are substantially neutral with a pH of from 7 to 7.5, and then soaked overnight for handsheeting.

Prepare two sets of standard handsheets according to Tappi method T 205, “Forming handsheets for physical tests of pulp”, for each tine interval. One set will be made from pulp that has not been treated with sodium hydroxide and will be the control set. The other set will be prepared from fibers that have been exposed to alkali for the designated time interval. These two sets of handsheets will be prepared on the same day. Each set of handsheets will be tested for zero-span tensile according to Tappi method T 231, “Zero-span breaking strength of pulp (dry zero-span tensile)”.

Determine the zero-span stability ratio, ZSSR, by dividing the zero-span tensile result of the alkali treated sample by the zero-span tensile result from the corresponding untreated control sample. The results can be reported as a decimal ratio, such as 0.921 or as a percentage, such as 92.1 percent. Reporting three significant figures is recommended.

The zero span stability ratios will be reported individually for each time interval sample and/or as an average value of all the time interval samples tested. Note that higher ratios will be observed for pulps that have greater strength stability in an alkaline environment.

Report the zero-span stability ratios, ZSSR, determined for each time interval sample as a decimal fraction or as a percentage along with the average zero-span stability ratio determined from all time interval samples. Since 1N NaOH is the standard test solution, it need not be specified, but if another test solution is used in addition to the standard solution, its composition must be specified.

Precision and bias for the zero-span tensile test are given in TAPPI T 231. Repeatability within a laboratory is from 3-5 percent, and reproducibility between laboratories, 30 samples at 3 laboratories, was 10 percent. Repeatability of zero span tensile tests used to calculate stability ratios was found to be 5 percent based on 14 sets of control handsheets made at different times by two operators where each set was tested four times by cutting two test strips from two handsheets from each set for a total of 64 pulls.

Repeatability of the stability ratio is partly dependent on the type of fibers tested, such as, for example, SSK, NSK, sulfite, mechanical, etc., and the duration of the test, for example, 1 day, 1 week, 4 weeks. For samples determined in uncovered beakers, the repeatability, expressed as a percent coefficient of variation, was 5-8 percent.

This invention is a fiber reinforced cement based or cementitious material where the reinforcing fiber is a chemically purified cellulose fiber. As used herein, the phrase “chemically purified cellulose fiber” means a cellulose fiber that has been processed to produce fibers that have not been chemically treated as in U.S. patent application Ser. No. 10/638,274, and which have not been mineralized, but, which, nevertheless, exhibit an alkaline stability value (ZSSR) as defined in ASTM D6942-03 that is about 90 percent or greater, more desirably, of about 93 percent or greater, preferably, of about 95 percent or greater and more preferably, of about 97 percent or greater. It is shown in the experimental section that achieving a ZSSR value in excess of 90 percent requires purification of the fibers to levels greater than 90 percent cellulose. Thus, chemically purified cellulose fibers useful in the practice of this invention have a cellulose content of about 90 percent or greater, more desirably of about 93 percent or greater, preferably of about 95 percent or greater and more preferably of about 97 percent or greater.

Cellulosic fibrous materials suitable for use in the present invention include softwood fibers and hardwood fibers. See M. J. Kocurek & C. F. B. Stevens, Pulp and Paper Manufacture—Vol. 1: Properties of Fibrous Raw Materials and Their Preparation for Pulping, which is hereby incorporated by reference in its entirety, The Joint Textbook Committee of the Paper Industry, 1983, 182 pp. Exemplary, though not exclusive, types of softwood pulps are derived from slash pine, jack pine, radiata pine, loblolly pine, white spruce, lodgepole pine, redwood, and douglas fir. North American southern softwoods and northern softwoods may be used, as well as softwoods from other regions of the world. Hardwood fibers may be obtained from oaks, genus Quercus, maples, genus Acer, poplars, genus Populus, or other commonly pulped species. In general, softwood fibers are preferred due to their longer fiber length as measured by T 233 cm-95, and southern softwood fibers are most preferred due to a higher coarseness as measured by T 234 cm-84, which leads to greater intrinsic fiber strength as measured by breaking load relative to either northern softwood or hardwood fibers.

The fibrous material may be prepared from its natural state by any pulping process. These industrial processes are described in detail in R. G. Macdonald & J. N. Franklin, Pulp and Paper Manufacture in 3 volumes; 2^{nd} Edition, Volume 1: The pulping of wood, 1969, Volume 2: Control, secondary fiber, structural board, coating, 1969, Volume 3: Papermaking and paperboard making, 1970, The joint Textbook Committee of the Paper Industry, and in M. J. Kocurek & C. F. B. Stevens, Pulp and Paper Manufacture, Vol. 1: Properties of Fibrous Raw Materials and Their Preparation for Pulping, The joint Textbook Committee of the Paper Industry, 1983, 182 pp., both of which are hereby incorporated by reference in their entirety.. Preferably, the fibrous material is prepared by a chemical pulping process, such as a Kraft or sulfite process. In particular the Kraft process is especially preferred. Pulp prepared from a southern softwood by a kraft process is often called SSK. In a similar manner, southern hardwood, northern softwood and northern hardwood pulps are designated SHK, NSK & NHK, respectively. Bleached pulp, which is fibers that have been delignified to very low levels of lignin, are preferred, although unbleached kraft fibers may be preferred for some applications due to lower cost, especially if alkaline stability is not an issue. Desirably, the chemically treated cellulose fiber has been derived from a source which is one or more of Southern Softwood Kraft, Northern Softwood Kraft, hardwood, eucalyptus, mechanical, recycle and rayon, preferably Southern Softwood Kraft, Northern Softwood Kraft, or a mixture thereof, more preferably, Southern Softwood Kraft.

In addition to high purity cellulose fibers obtained from cotton linters, high purity cellulose fibers can be prepared from wood. The two major processes for manufacture of these high purity cellulose fibers are the acid sulfite process and the prehydrolyzed Kraft process.

Detailed descriptions of the acid sulfite process may be found in Pulping Processes, S. A. Rydholm ed., pp. 439-576, 1965, Interscience Publishers, New York; and in Pulp and Paper Manufacture Vol. 4—Sulfite Science & Technology, O. V. Ingruber, M. J. Kocurek & A.. Wong eds., pp. 229-243, 1985, Technical Section—Canadian Pulp & Paper Association, Montreal, Quebec, Canada.

In a typical example, wood chips are subjected to a solution of sulfur dioxide dissolved in water at temperatures up to 150° C. in a pressurized digester for 4 to 6 hours. At the end of this period the contents of the digester are vented to atmospheric pressure allowing the digested chips to move through a pipe driven by higher than atmospheric pressure to a receiving vessel. While in transit, the chips defiber into individualized fibers. These fibers or unbleached wood pulp are washed with fresh water to remove residual chemicals and wood components separated from the fibers during the sulfite process. After washing, the residual lignin and non-cellulosic materials in the fibers are removed in a multistage bleaching process, using in individual steps chlorine, sodium hydroxide, sodium hypochlorite, and chlorine dioxide. The final products are cellulose fibers with greater than 98 percent purity.

Detailed descriptions of the prehydrolyzed Kraft process may be found in Pulping Processes, S. A. Rydholm ed., pp. 576-649 & 655-672, 1965, Interscience Publishers, New York; and in Pulp and Paper Manufacture Vol. 5—Alkaline Pulping, T. M. Grace, E. W. Malcom & M. J. Kocurek eds., pp. 1989, The Joint Textbook Committee of the Paper Industry—CPPA: Montreal, Quebec, Canada & TAPPI: Atlanta, Ga., USA.

In a typical example, wood chips are subjected to steam in a pressurized digester at temperatures up to 350° F. for 30 minutes. This prehydrolysis extracts much of the hemicelluloses in wood that are resistant to alkali. The steam condensate from this step is drained from the digester, and the prehydrolyzed wood chips are subjected to an aqueous solution of sodium hydroxide, sodium sulfide and sodium hydrosulfide in a pressurized digester at temperatures up to 175° C. for 90 minutes. At the end of that period, the contents of the digester are discharged by venting into a large pipe at atmospheric pressure, leading to a receiving vessel. While in transit, the chips defiber into individual fibers. The fibers or unbleached wood pulp are washed with fresh water to remove residual chemicals and water soluble wood components. The unbleached fibers are subjected to individual bleaching and purification steps using chlorine, chlorine dioxide, sodium hydroxide and sodium hypochlorite. The final products are cellulose fibers with greater than 98 percent purity.

The purity of cellulose fibers is specified based on its weight percent of cellulose. The most common designation of cellulose is the alpha (α) cellulose content. For example, a pulp with α=95, has a cellulose content of 95 percent. The procedure for measurement of the α cellulose content is based on insolubility in aqueous sodium hydroxide. The α cellulose is that fraction of the cellulose fibers that is insoluble in both 17.5 percent aqueous sodium hydroxide and insoluble in 9.75 percent aqueous sodium hydroxide. The procedure is described in TAPPI Standard T 203. A second frequently used method for specifying cellulose purity is alkali solubility in 10 percent aqueous sodium hydroxide, known as S₁₀ and which may also be indicated by S-10 or S10. This S₁₀ data is a measure of hemicellulose solubility in the aqueous alkali. Subtracting the S₁₀ from 100 provides approximately the same figure as the α cellulose content of the sample. The S₁₀ procedure is described in TAPPI Standard T 235. As used herein for bleached pulp, “percent cellulose” means 100-S₁₀.

In one embodiment, the cellulose fibers suitable for use in this invention are individualized chemically purified cellulose fibers having a length of from about 0.1 to about 10 mm, a diameter of from about 0.001 to about 0.1 mm and having length-to-diameter ratios of from about 30 to about 3000. The cellulose fiber reinforced cementitious material of this invention is produced by combining the fibers with cement, water and sand, aggregate, or sand and aggregate. The cellulose fibers are derived from chemical, mechanical or thermal means, or combinations thereof, from non-wood plants, wood plants and recycled paper products, with the individualization process reducing the bonding between fibers so that they can be dispersed in conventional concrete mixtures using conventional mixing equipment at relatively low dosages of from about 0.1 kg/m³ to about 30 kg/m³ of the chemically purified cellulose fiber. The affinity of individualized pulp fibers for water facilitates their dispersion in concrete. The fresh concrete mixtures incorporating dispersed plant pulp fibers possess desirable workability, resistance to segregation and bleeding, pumpability, finishability, resistance to plastic shrinkage cracking, and reduced rebound when pneumatically applied.

Some embodiments of this invention require a substantial weight percent of the cementitious material to be the chemically purified fiber, while other embodiments make use of a very small weight percent fiber. Generally, the chemically purified cellulose fiber content of the cementitious material is from about 0.01 weight percent to about 20 weight percent based on the weight of the cementitious material, more often, from about 0.01 weight percent to about 10 weight percent based on the weight of the cementitious material, desirably, from about 0.01 weight percent to about 3 weight percent based on the weight of the cementitious material, more desirably, from about 0.01 weight percent to about 1 weight percent based on the weight of the cementitious material, preferably, from about 0.01 weight percent to about 0.5 weight percent based on the weight of the cementitious material, more preferably, from about 0.01 weight percent to about 0.1 weight percent based on the weight of the cementitious material.

Inorganic binders useful for the present invention include water-curable inorganic substances which form a matrix upon a setting, such as cement based materials, calcium silicate materials, and mixtures thereof. The chemistry of such compositions is described in P. K. Mehta and P. J. M. Monteiro, Concrete Structure, Properties, and Materials, Prentice Hall, 1993, [548 pp.] and P. C. Hewlett, Lea's Chemistry of Cement and Concrete, Fourth Edition, Butterworth-Heinemann, 1998, [1056 pp.], both of which are hereby incorporated by reference in their entirety.

As used herein, cement based or cementitious materials refers to compositions generally comprising lime, alumina, silica, and iron oxide. Applicable cement based materials include Portland cement, aluminous cement, blast furnace cement, and mixtures thereof. Portland Cement is especially contemplated for use with the present invention. In general, Portland cement is composed primarily of tetracalcium aluminoferrate (4 CaO Al₂O₃ Fe₂O₃), tricalcium aluminate (3 CaO Al₂O₃), tricalcium silicate (3 CaO SiO₂), and dicalcium silicate (2CaO SiO₂). Each of the five conventional types of Portland cement and white Portland cement may be used as the inorganic binder. These include moderate heat-of-hardening cement known in the art as Type II, high early strength (H.E.S.) cement known as Type III, low heat cement known as Type IV, and chemical resisting cement known as Type V. Especially contemplated is Type I cement which commonly used for a variety of general construction purposes. It is within the ability of one of ordinary skill in the art to modify and adjust the relative proportions of the components of Portland cement in order to enhance a particular property or prepare any of the conventional types of Portland cement, including white Portland cement, listed above.

Preparing the chemically purified cellulose fibers for use in the cementitious mixture can be accomplished easily.

Method 1: The chemically purified cellulose fibers are supplied in typical sheeted roll form with approximate sheet physical properties of basis weight about 710 g/m² and density about 0.59 g/cm³. The sheet is fed into a pulp sheet disintegrator, such as, for example, a Kamas Mill, whereby the sheet form is converted into fluff form of much lower density which is from about 0.05 g/cm³ to about 0.25 g/cm³. The fluffed fibers are then metered into specific weights and packaged as such into small bags made of degradable material that disintegrates when placed in contact with water. These small bags are supplied to the concrete manufacturer where they are simply thrown into the concrete mix, bag and individualized chemically treated cellulose fibers, at the appropriate time to be uniformly distributed into the entire concrete batch. Based on the desired fiber loading, for example, in kg of fibers per m³ of concrete, the appropriate weight and number of bags are used.

Method 2: The cellulose fibers are supplied in typical sheeted bale form with approximate sheet physical properties for basis weight of about 710 g/m² and density about 0.59 g/cm³, to a concrete manufacturing site. Pulp sheets are then loaded into a tank containing water and an adequate agitator such that the sheets are blended with the water to form a uniform slurry of individual pulp fibers with a consistency ranging from 0.1 percent to 3.0 percent by weight. During the concrete mixing process, the appropriate volume of the fiber and water slurry is pumped into the concrete mixing truck to supply the needed water and fiber content for the concrete batch and to allow uniform distribution.

The chemically purified cellulose fibers of this invention may made from sheeted cellulose in the form of twisted dice form of sheeted fibrous material in which the twisted dice has a generally rectangular shape with an unkinked length of from about 10 mm to about 100 mm, a width of from about 2 mm to about 15 mm and a thickness of from about 1 mm to about 6 mm, a density of from about 0.1 g/cc to about 0.5 g/cc, and where the dice has one or more twists of 45 degrees or more along its length, or of rectangular dice form of sheeted fibrous material in which the rectangular dice has a generally rectangular shape with a length of from about 4 mm to about 10 mm, a width of from about 3 mm to about 8 mm and a thickness of from about 1 mm to about 2 mm, a density of from about 0.4 g/cc to about 0.6 g/cc.

In an alternative embodiment of this invention, chemically purified cellulose fibers are used to produce a nonwoven material, for example, by an airlaid process, and the nonwoven material is used as a reinforcement in a cementitious mixture.

In another embodiment of this invention, the chemically purified cellulose fibers hereinabove described are used in a cementitious material in the form of a reinforcement mixture or blend comprising one or more other reinforcement materials. These may be one or more fibers which are synthetic or natural fibers, such as, for example, thermoplastic fibers, polyolefin fibers, polyethylene fibers, polyester fibers, nylon fibers, polyanide fibers, polyacrylonitrile, polyacrylamide, viscose, wool, silk, polyvinyl chloride, polyvinyl alcohol, metal fibers, carbon fibers, ceramic fibers, steel fibers (straight, crimped, twisted, deformed with hooked or paddled ends), glass fibers, carbon fibers, natural organic and mineral fibers (abaca, asbestos, bamboo, coconut, cotton, jute, sisal, wood, rockwool), polypropylene fibers (plain, twisted, fibrillated, with buttoned ends), kevlar, rayon. In another embodiment of this invention, the chemically purified cellulose fibers hereinabove described are used in a cementitious material, either alone or in a blend with other fibers, where the cementitious material contains a latex or a mixture of latexes.

The cementitious materials of this invention are useful for making a wide variety of poured structures, structures that each of us sees every day, such as, for example, highways, roads, sidewalks, driveways, parking lots, concrete buildings, bridges, and the like.

Test Methods:

Measurements of purity are usually based on what is termed α-cellulose content. Pulp fibers contain three basic types of polymers: cellulose, hemicellulose, and lignin. Bleached fibers have had almost all of the lignin polymer removed during processing. The α-cellulose content of bleached samples is determined by extracting the pulp with 10 percent sodium hydroxide. Hemicelluloses and degraded cellulose dissolve in the alkaline solution, and the amount removed is referred to as the S₁₀ value in percent. (See Tappi Standard T 235.) If this value is subtracted from 100 percent, a good estimate of the α-cellulose content is obtained. For unbleached pulps, such as brownstocks, the α-cellulose content is determined by subtracting both the S₁₀ value in percent and the percent lignin value from 100 percent. The percent lignin value is calculated from the brownstock K-number. And, therefore, as used herein for bleached pulp, “percent cellulose” means 100-S₁₀, and for brownstock, “percent cellulose” means 100-S₁₀-percent lignin.

Pulp consistency is a pulp-industry specific term which is defined as the bone dry fiber amount divided by the total amount which includes fiber, water, other solids, etc. and multiplied by 100 percent. Therefore, for a slurry of 12 percent consistency, every 100 kilograms of slurry would contain 12 bone dry kilograms of fiber.

### EXAMPLES

The following Examples illustrate the invention, but are not limiting.

### Example 1

Preparation of Brownstock and Bleached Southern Softwood Kraft (SSK) Pulps:

Wood chips of predominantly slash pine were pulped through a Kraft process to a permanganate number (K number) of about 17 ml as determined by the procedure described in TAPPI method T 214 and the S₁₀ value (Tappi T-235) measured was 9.34 percent. These fibers were washed and screened for quality and then bleached with a D-E_{OP}-D-E_{P}-D process to

an ISO brightness of about 86 percent. Viscosity, as measure by T 230, was about 16 cP. S₁₀, as measured by T 235, was 12.78 percent. In this process, D is a chlorine dioxide stage, Eop is an extraction stage with the addition of oxygen and hydrogen peroxide, and Ep is an extraction stage with hydrogen peroxide added.

These bleached cellulose fibers were diluted with water to a slurry consisting of 0.9 parts fiber per 100 parts slurry at a pH of 6.5. The resultant slurry was continuously dewatered on a sheeting machine where the sheet was formed at a 1.0 rush/drag ratio, couched, then pressed and densified using three stages of wet pressing to 48 parts fiber per 100 parts total. The sheet was dried using conventional drum dryers to a solids content of 94 percent. The reeled pulp was then processed into individual rolls. This fiber is commercially available as FOLEY FLUFFS® from Buckeye Technologies of Memphis Tenn.

Samples of SSK pulp before bleaching (FFbs) and after the bleach sequence described above (FF) were submitted to the alkaline stability test described below. (See example 6.)

### Example 2

Northern Softwood Kraft (NSK) Pulps:

Commercial samples of northern softwood kraft brownstock and fully bleached pulps, prepared from northern pine and spruce chips in a manner similar to the process described above, were also subjected to the alkaline stability test. The K-number of the brownstock sample was 25 and its chlorited viscosity was 37 cP.

Samples of NSK pulp before (NSKbs) and after bleaching (NSK) were submitted to the alkaline stability test described below. (See example 6.)

### Example 3

Prehydrolyzed Dissolving SSK Pulps

Commercial samples of purified, fully bleached southern pine kraft pulps were subjected to the alkaline stability test. These samples differ from the sample in example 1 in that they were given a prehydrolysis treatment to reduce the amount of hemicellulose in the pulp. The sample designated V-60 is less pure than the V-5 sample because it received a less severe prehydrolysis treatment, and because it did not receive a cold caustic extraction. The caustic extraction procedure that the V-5 product received increases its purity by removing more of the hemicellulose and degraded cellulose present in the pulp.

Samples of these prehydrolyzed SSK pulps designated V-60 and V-5 as described above were submitted to the alkaline stability test described below. (See example 6.)

### Example 4

Mercerized SSK Pulp

A commercial sample of purified, fully bleached southern pine kraft pulp was subjected to the alkaline stability test. This sample, designated HPZ, differs from the samples in example 3 in that it is not prehydrolyzed. A mercerizing treatment with strong, cold caustic removes a significant portion of the hemicelluloses from the fibers, increasing its purity as indicated by a lower S₁₀ level.

A samples of the SSK derived HPZ pulp described above was submitted to the alkaline stability test described below. (See example 6.)

### Example 5

Purified Cotton Linters Pulps

Two purified cotton linter pulps were subjected to the alkaline stability test. One sample, grade 505, is used to make fine paper and receives a more severe pulping treatment with sodium hydroxide and more severe bleaching to a lower viscosity, 9.4 cP (Tappi T230) and higher brightness 90 percent. The other sample, HVE, is a dissolving grade intended for the preparation of high viscosity ethers, and has a brightness of 75.5 percent and a viscosity of greater than 13,000 ACS seconds (see ASTM D6188). This viscosity is equivalent to about 330 cP ( see Tappi T230).

Samples of the cotton linters pulps described above were submitted to the alkaline stability test described below. (See example 6.)

### Example 6

Determination of the Alkaline Stability (ZSSR) of Cellulose Fibers

This test method is described in detail in ASTM method D6942-03. This test method can be used to compare different cellulose pulp fiber types based on their response to standard alkaline solutions. The stability factor defined below can be used to measure the effect of exposure to alkaline conditions on fiber strength. Other methods for making handsheets and for determination of the zero-span tensile are referenced in this method and are herein included.

To 20 g (dry basis) of FOLEY FLUFFS® fibers in an uncovered beaker, 46.7 g of 1N NaOH was added and allowed to remain in the beaker for 24 hours. Additional samples were left to age for time intervals of 7, 14, and 28 days. When the time interval has passed, work-up of the samples was accomplished by collecting fibers on a wire screen, washing with tap water until washings are substantially neutral (pH=7 to 7.5), and then air drying. Control samples were prepared by using the procedure above with the substitution of distilled water for the 1N sodium hydroxide.

Two sets of standard handsheets were prepared according to TAPPI T 205 for each sample. One set, the control, was made from pulp that has not been treated with sodium hydroxide. The other set is prepared from fibers that have been exposed to alkali. These sets of handsheets were prepared on the same day. Each set of handsheets was tested for zero-span tensile according to TAPPI T 231.

The zero-span stability ratio (ZSSR) was calculated by dividing the zero-span tensile result of the alkali treated sample by the zero-span tensile result from the corresponding untreated (control) sample. The results are reported as a percentage, such as 92.1 percent The zero-span stability ratios are reported individually for each time interval sample and as an average value of all the time interval samples tested.

The procedure hereinabove described was used to test each of the pulp samples. A summary of the data is given in table 1.

TABLE 1
ZSSR Testing vs. Purity
Zero-Span Stability Ratio (percent)

| Day | NSKbs | FFbs | NSK | FF | HPZ | V60 | V5 | HVE | 505 |
|---|---|---|---|---|---|---|---|---|---|
| 1- | 80.2 | 86.4 | 88.9 | 87.9 | 101.5 | 89.8 | 90.3 | 99.4 | 99.6 |
| Day | | | | | | | | | |
| 7- | | 85.5 | 85.4 | 93.8 | 92.6 | 95.0 | 97.0 | 99.4 | 97.4 |
| Day | | | | | | | | | |
| 14- | 76.5 | 82.1 | 87.3 | 85.7 | 90.0 | 91.3 | 96.0 | 93.0 | 98.8 |
| Day | | | | | | | | | |
| 28- | 76.5 | 82.1 | 83.3 | 87.5 | 92.2 | 88.4 | 97.8 | 101.5 | 100.4 |
| Day | | | | | | | | | |
| Aver- | 77.7 | 84.0 | 86.2 | 88.7 | 94.1 | 91.1 | 95.2 | 98.3 | 99.0 |
| age | | | | | | | | | |

The average results on the bottom of the table have less variability than the individual days. The samples are listed in the estimated order of purity from left to right. It is clear that the ZSSR values increase from left to right, which demonstrates a direct relationship in which high ZSSR correlates with high cellulose purity.

Table 2 shows all of the data for purity and ZSSR.

TABLE 2
ZSSR, S-10 and Percent Cellulose

| | S₁₀ | %-cell. | d1 | d7 | d28 | D14 | % ZSSR |
|---|---|---|---|---|---|---|---|
| NSK_bs | 8.61% | 84.39% | 80.21% | | 77.74% | 76.50% | 76.52% |
| NSK | 15.40% | 84.61% | 88.93% | 85.37% | 86.21% | 87.27% | 83.26% |
| FF brownstock | 9.34% | 87.17% | 86.41% | 85.47% | 84.02% | 82.10% | 82.10% |
| FF (686927) | 12.79% | 87.21% | 87.93% | 93.76% | 88.74% | 85.73% | 87.55% |
| V60 (no Lot #) | 7.52% | 92.48% | 89.80% | 94.97% | 91.12% | 91.31% | 88.40% |
| HPZ (270178) | 3.18% | 96.83% | 101.55% | 92.58% | 94.08% | 90.01% | 92.20% |
| V5 (213716) | 3.01% | 97.00% | 90.28% | 96.96% | 95.24% | 95.95% | 97.76% |
| GRADE 505 | 2.50% | 97.51% | 99.56% | 97.40% | 99.03% | 98.79% | 100.37% |
| HVE | [symbol] 0% | 98.80% | 99.36% | 99.41% | 98.33% | 93.04% | 101.49% |

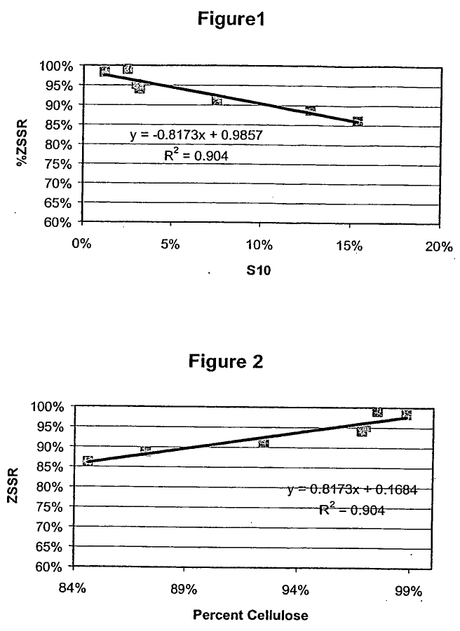

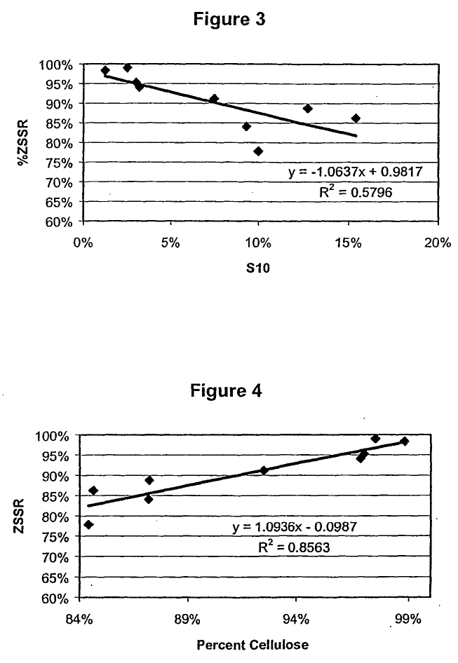

A plot of percent ZSSR versus S₁₀ or percent cellulose for bleached pulps gives the same correlation as shown in FIGS. 1 and 2. The results are somewhat different when the two brownstock samples are included as shown in FIGS. 3 and 4. In FIG. 3, the percent ZSSR values of all samples are plotted versus the S₁₀ value. In FIG. 4, the percent ZSSR values of all samples are plotted versus purity in which the percent cellulose value is determined by subtracting the S₁₀ value and the percent lignin remaining in the pulp fibers. The correlation improves, but is still less than for the bleached pulps. This suggests that residual lignin is more harmful to alkaline stability than hemicellulose. Overall, this data clearly shows that purification of the cellulosic fibers results in improved alkaline stability, as measured by the ASTM method D6942-03.

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

Patents, patent applications, publications, product descriptions, and protocols are cited throughout this application, the disclosures of which are incorporated by reference herein in their entireties for all purposes.

What is claimed is:

1. A cellulose fiber reinforced cementitious material comprising
(A) cement,
(B) optionally, sand, aggregate, or sand and aggregate, and
(C) chemically purified cellulose fibers having a ZSSR of about 90 percent or greater.

2. The material of claim 1, wherein the chemically purified cellulose fibers have a ZSSR of about 93 percent or greater.

3. The material of claim 2, wherein the chemically purified cellulose fibers have a ZSSR of about 95 percent or greater.

4. A cellulose fiber reinforced cementitious material comprising
(A) cement,
(B) optionally, sand, aggregate, or sand and aggregate, and
(C) chemically purified cellulose fibers having a percent cellulose content of about 90 percent or greater.

5. The material of claim 4, wherein the chemically purified cellulose fibers have a percent cellulose content of about 93 percent or greater.

6. The material of claim 5, wherein the chemically purified cellulose fibers have a percent cellulose content of about 95 percent or greater.

7. A cellulose fiber reinforced cementitious material comprising
(A) cement,
(B) optionally, sand, aggregate, or sand and aggregate,
(C) chemically purified cellulose fibers having a ZSSR of about 90 percent or greater, and
(D) one or more synthetic or natural fibers which are chemically treated cellulose fibers; thermoplastic fibers; polyolefin fibers; polyethylene fibers; polyester fibers; nylon fibers; polyamide fibers; polyacrylonitrile fibers; polyacrylamide fibers; viscose fibers; wool fibers; silk fibers; polyvinyl chloride fibers; polyvinyl alcohol fibers; metal fibers; carbon fibers; ceramic fibers; straight, crimped, twisted, deformed with hooked or paddled ends steel fibers; glass fibers, abaca fibers; asbestos fibers; bamboo fibers; coconut fibers; cotton fibers; jute fibers; sisal fibers; wood fibers; rockwool fibers; plain, twisted, fibrillated, with buttoned ends polypropylene fibers; kevlar fibers; or rayon fibers.

8. The material of claim 7 further comprising a latex.
